(19) United States
(12) Patent Application Publication
(10) Pub. No.: US 2019/0086723 A1
(43) Pub. Date: Mar. 21, 2019

(54) ELECTRONIC MIRROR WITH AN ENHANCED SWITCH-ABLE LENS SYSTEM

(71) Applicant: VISTEON GLOBAL TECHNOLOGIES, INC., Van Buren Township, MI (US)

(72) Inventor: Paul Fredrick Luther Weindorf, Novi, MI (US)

(21) Appl. No.: 15/710,018

(22) Filed: Sep. 20, 2017

(51) Int. Cl. G02F 1/1335; B60R 1/04; B60R 1/08; B60R 1/12

(52) U.S. Cl. CPC G02F 1/133536; G02F 1/133502; G02F 1/133526; B60R 1/04; B60R 2001/1253; B60R 1/12; G02F 2001/133562; G02F 2001/133567; B60R 1/088

(57) ABSTRACT

An electronic-mirror (e-mirror) system is disclosed herein. The system includes a backlit display configured to present content; a first reflective polarizer layer overlapping the backlit display; an air gap layer introduced between the backlit display and the first reflective polarizer; a rotator cell layer directly overlapping the first reflective polarizer; a second reflective polarizer directly overlapping the rotator cell; a switch-able polarizer directly overlapping the second reflective polarizer; and a lens directly overlapping the switch-able polarizer. Also included herein is an index matched interface and front anti-reflective film, thereby allowing the e-mirror to be both in the states of a reflective and electronic display mode without requiring a toggling towards a low luminance surface.

### BACKGROUND

Electronic displays are provided in many contexts to electronically render digital information to a viewer. The electronic displays receive information, and renders the information through lighted cells in patterns that reflect the texts and pictures employed to convey the information.

In the vehicular space, information has traditionally been conveyed via mechanical elements (gauges, lights, rotating digits). In recent times, mechanical displays have been replaced with electronic displays in both the instrument cluster area (the space traditionally behind the steering wheel and embedded in a dashboard) and the infotainment area.

Electronic-mirrors (e-mirrors) are newly being developed to also convey information. E-mirrors exist in two distinct states: a reflective state (i.e. mirror mode) and a display state. Conventionally, multiple layers are provided in an overlapping fashion. If display information is requested, a switch-able lens is converted to be primarily transparent. Conversely, the switch-able lens is converted to primarily be reflective.

### SUMMARY

The following description relates to providing a system, method, and device for an e-mirror system with an enhanced switch-able lens assembly. Exemplary embodiments may also be directed to any of the system, the method, or an application disclosed herein, and the subsequent implementation in a vehicular context.

[To be Finalized when Claims are Set]

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIGS. 1(a) and (b) illustrate an example of an e-mirror;

FIGS. 2(a)-(c) illustrate an e-mirror employing a switchable lens system;

FIG. 3 illustrates a diagram illustrating an implementation of an e-mirror employing an enhanced switch-able lens system according to an exemplary embodiments;

FIG. 4 illustrates a cross-sectional diagram of an e-mirror system;

FIGS. 5(a)-(e) illustrate the operation of the e-mirror system according to system shown in FIG. 4 in a reflection mode;

FIGS. 6(a)-(e) illustrate the operation of the e-mirror system according to system shown in FIG. 4 in a display mode;

FIGS. 7(a) and (b) illustrate a side-view of a e-mirror system according to a first and second embodiment;

FIG. 8 illustrates a side-view of a e-mirror system according to a third embodiment; and

FIG. 9 illustrates a e-mirror operating with an application employing aspects disclosed herein.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

An electronic mirror (e-mirror) is a display device that allows content to be viewable in a first state and to be a mirror in a second state.

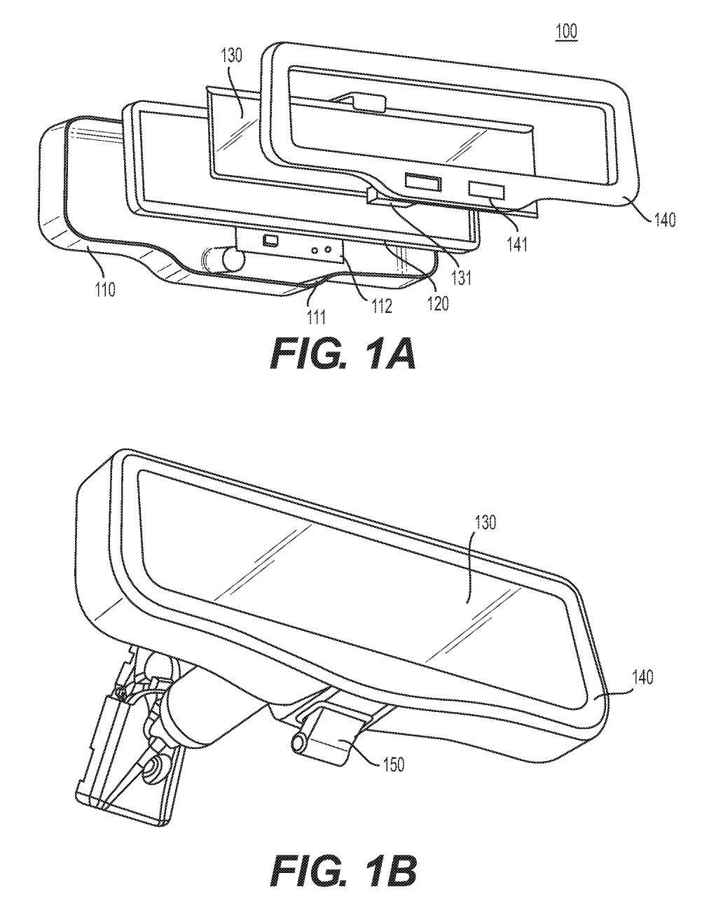

FIGS. 1(a) and (b) illustrate an exemplary e-mirror 100, the subject of which that will be the focus of the disclosed concepts described herein. Referring to FIG. 1(a), an exploded-view is presented with each individual component separately shown. Referring to FIG. 1(b), the e-mirror 100 in a fully assembled view is illustrated.

A rear cover 110 is provided and serves as a housing for the remaining components. Specifically, the rear cover includes a circuit board 112 with a switch 111 mounted thereon. The switch 111 may be coupled to a mechanical or electrical stimulus, and when asserted, causes the e-mirror 100 to switch modes from a reflective state to a display state.

The first layer disposed on the rear cover 110 is an electronic display 120. The electronic display 120 may be any sort of device capable of digitally rendering information for display. Overlapping the display 120, is a lens 130. The lens 130 is switch-able to allow the display 120 to be viewable in one-mode and reflective in another mode. The lens 130 may be provided with a button assembly 131, viewable via an aperture in a front bezel 140. When the button assembly 131 is asserted, the switch 111 may be initiated, thereby switching the e-mirror 100 from display mode to reflective mode. Also provided is a sensor 141 disposed on the front bezel 140. The rear looking sensor 141 and a front looking sensor (not shown) may record ambient lighting conditions, and be employed to adjust the luminance on the display or the mirror reflectance of lens 130 accordingly.

As shown in FIG. 1(b), e-mirrors may employ a toggle 150. In order to view the e-mirror 100 in a display mode, the e-mirror 100 has to be oriented at a roof (or another low luminance surface) This is due to limitations of current switch-able lenses. Thus, the toggle switch 150 re-adjusts the e-mirror 100 so that it is in a state of being oriented at a roof of the vehicle (during a display mode), and a state of being oriented in a back portion of the vehicle (during a mirror mode).

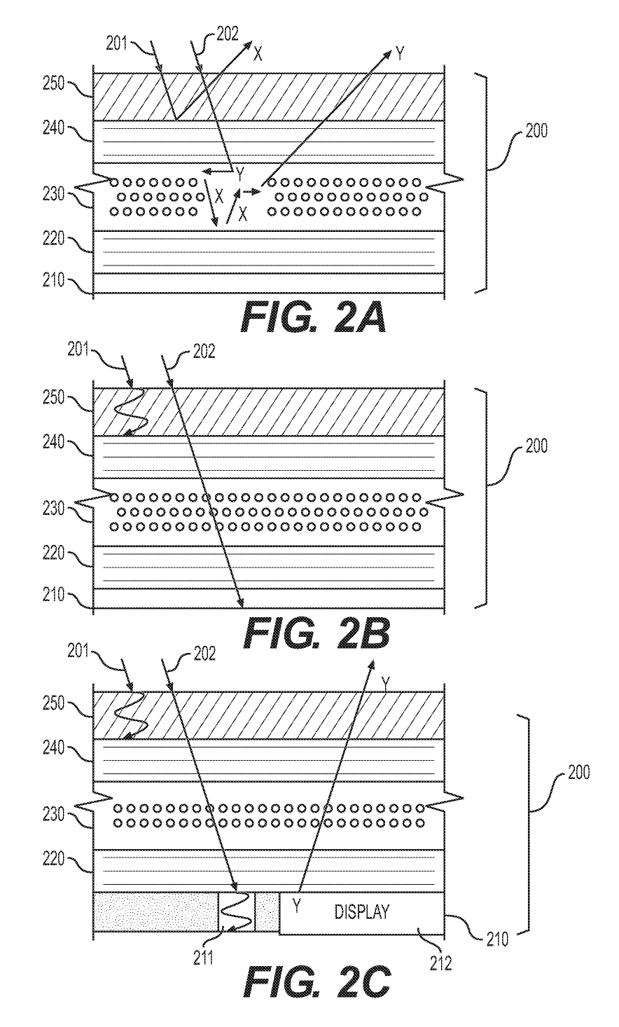

These devices may employ switch-able lens assemblies, such as the device 200 shown in FIGS. 2(a)-(c).

Referring to the device 200, three states are shown, each being individually illustrated in a respective one of FIGS. 2(a)-(c). The device 200 (e-mirror) includes a display assembly 210, with a beam stop 211 and a display 212, which also is substantially a beam stop. Overlapping the display assembly 210, and in physical abutment is a first reflective polarizer layer 220.

Overlapping the first reflective polarizer layer 220 is a switch-able liquid crystal layer (or rotator layer) 230. The switch-able liquid crystal layer 230 is electrically coupled to a control voltage source (not shown). The control voltage source can be applied so that the crystals are either orthogonal to the display assembly 200 and or perpendicular to the display assembly 200. When the crystals are parallel to the display assembly 200, the light's polarization is rotated.

Overlapping, and in physical abutment as shown, with the switching liquid crystal layer 230 is a second reflective polarizer layer 240. The second reflective polarizer layer 240 is overlapped with switch-able polarizer 250. The switch-able polarizer 250 is electrically coupled to a control voltage source (not shown).

FIG. 2(a) illustrates a non-energized state (so essentially no voltage is applied to any of the layers shown). In this instance, light from both 201 and 202 is reflected. Light 201 is of a first polarized state, and light 202 is of a second polarized state (orthogonal to the first state). In FIG. 2(a), both light 201 and 202 are reflected to a viewer of the e-mirror 200.

In FIG. 2(b), the device 200 is energized. In this state, light 201 is absorbed by the switchable polarizer, but light 202 is allowed through (not rotated) to be absorbed by the display or beam stop (light absorber) outside of the display area. FIG. 2(c) illustrates an example of introducing a beam stop 211 and a display 212. The beam stop 211 is capable of absorbing light 202 entering the cell. Accordingly, in response display 212 is configured to display content via the same polarization as light 202 at a luminance. The display luminance needs to be set to the level such that the reflected image is not noticeable which is much higher than the luminance required just for visibility.

As explained in the Background section, employing a construction such as that shown in FIGS. 2(a)-(c) leads to the requirement of implementing a toggle switch to orient the display to a neutral background, such as a roof of the vehicle, when in the display mode.

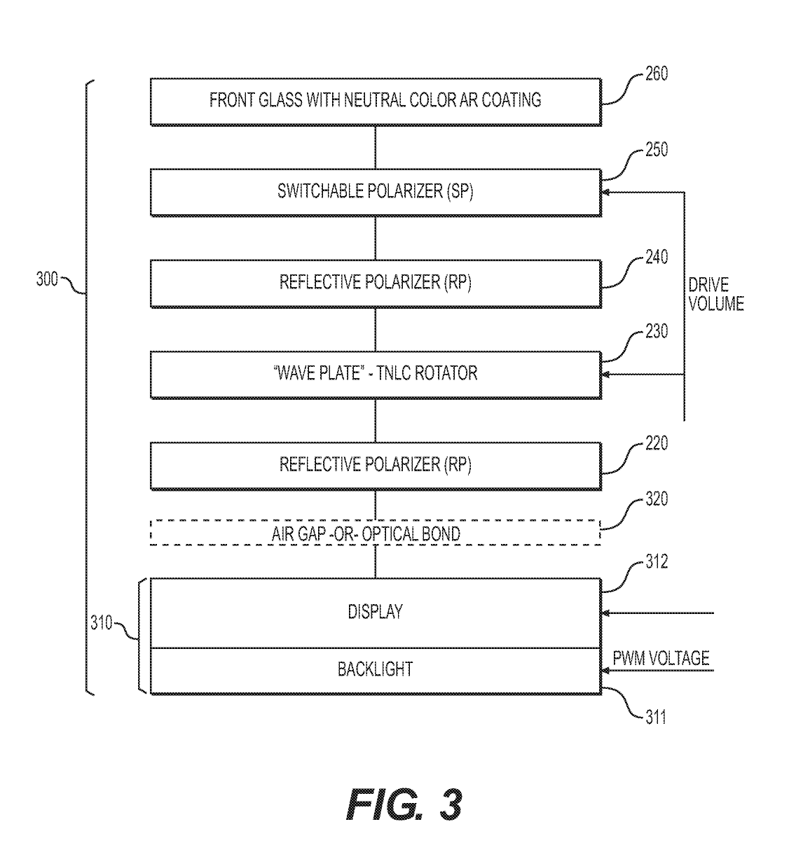

FIG. 3 illustrates a diagram of the e-mirror 300 employing the aspects disclosed herein. Referring to FIG. 3, a display assembly 310 is provided. The display assembly 310 includes a backlight 311 and a display 312. The backlight 311 sources light to the display 312, which based on liquid crystal cell-based technology, determines a pattern to illuminate and make viewable to a viewer of the e-mirror 300.

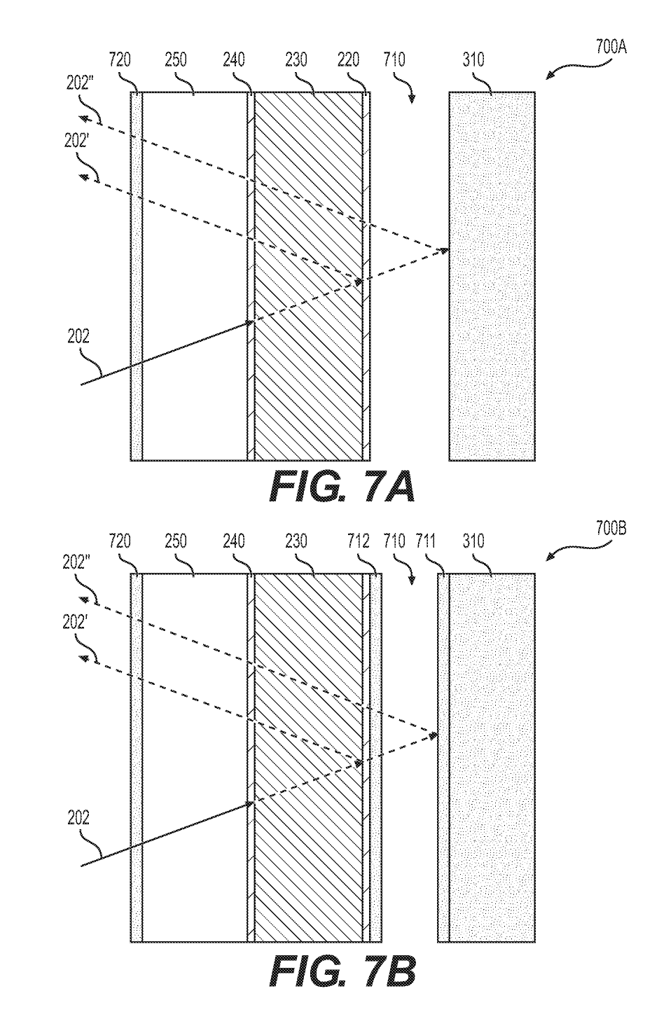

Layer 320 (or index matching layer 320) is provided to overlap the display assembly 310. FIGS. 7(a), (b) and 8 illustrate various embodiments of e-mirror 300 employing variations for this layer. Whenever there is an air to glass interface, a 4% reflection is introduced because only half of the light gets through. Each interface reflects 2% for a total of 4% if optical bonding is not used. If optical bond 220 is introduced, there is minimal reflection and the light passes to the display to be absorbed. Also if when index matching the glass to air or front display polarizer to air with AR coating or motheye film, the light is minimally reflected at these interfaces. Layer 260 is provided to overlap the switchable polarizer and includes a front surface antireflection (AR) layer to reduce the reflection rate by approximately 4%.

The following embodiments have been introduced in this disclosure:

1) An air gap with anti-reflective layers; and

2) Liquid Optical Clear Adhesive (LOCA) ,or Optically Clear Adhesive (OCA).

Overlapping the optically index matched layer 320 is a structure similar to that shown in FIGS. 2(a)-(c). Overlapping the structure as shown in FIGS. 2(a)-(c) is a front glass with AR on the front surface. The switch-able polarizer 250 is configured to switch polarization state based on an applied voltage.

E-mirror 300 is either on (+Drive Voltage) or off (+Drive Voltage removed). The on (display mode) and off (reflective mode) states will be described in greater detail below with the following descriptions and figures. Similarly, a pulse width modulated (PWM) voltage may be applied to the various backlit displays described herein.

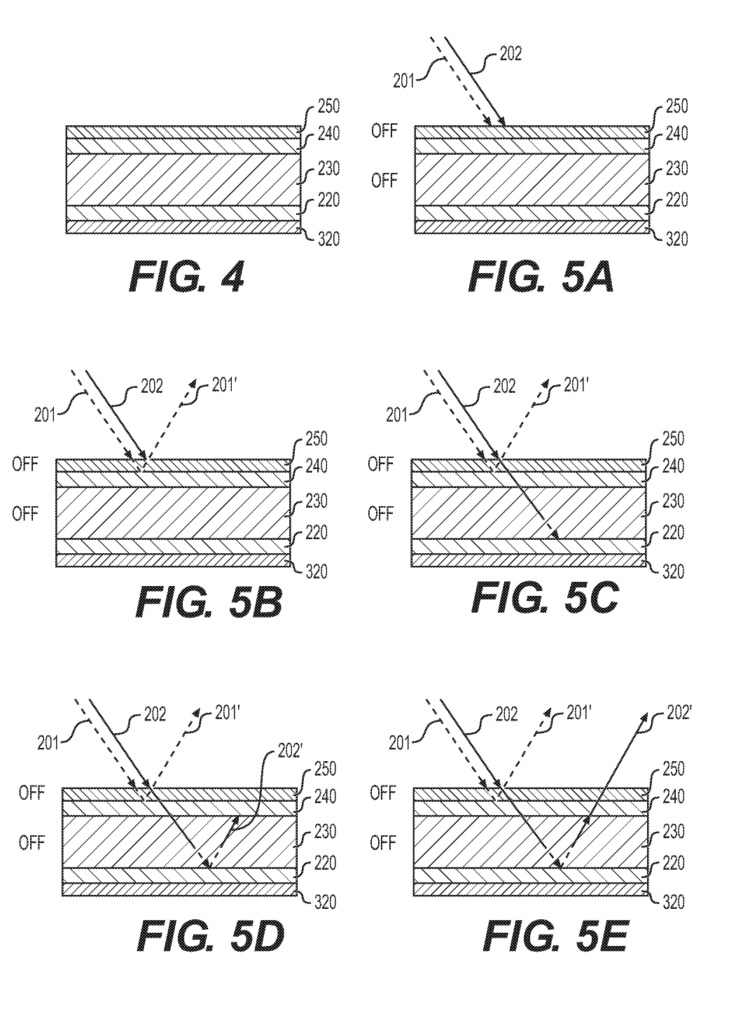

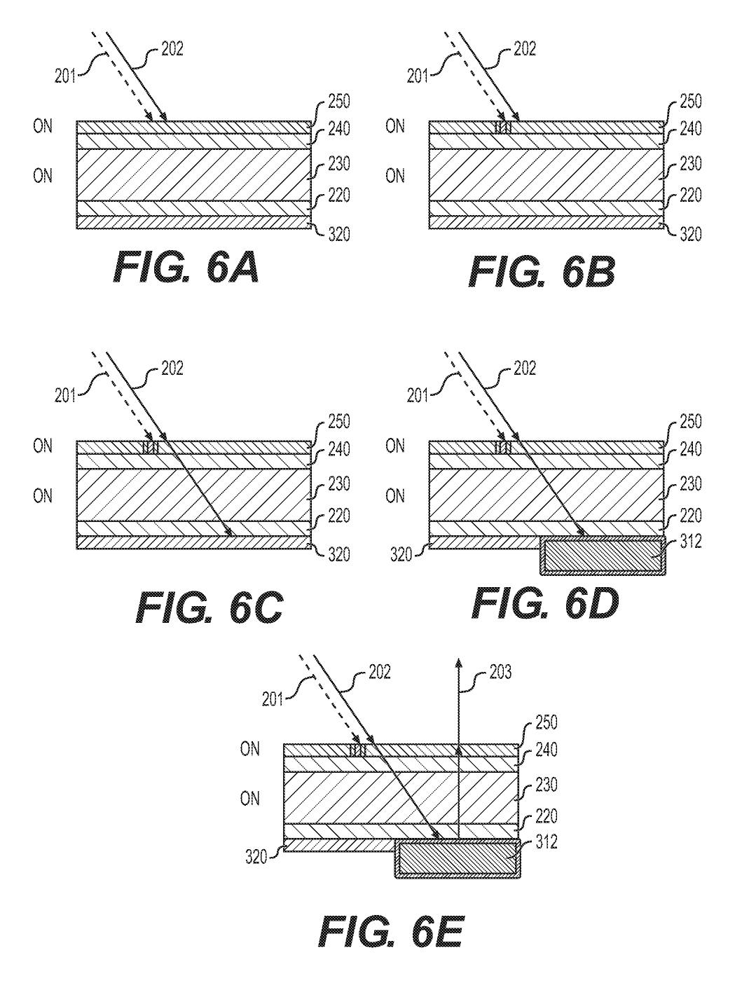

Referring to FIG. 4, a cross-sectional diagram of relevant portions for explaining e-mirror 300 is shown. The layers shown are in physical abutment with either where shown in FIG. 4 and the following illustrative diagrams. FIG. 4 is replicated in FIGS. 5(a)-(e) and FIGS. 6(a)-6(e).

FIGS. 5(a)-(e) illustrate a cross-sectional diagram of e-mirror 300 when both the switch-able polarizer layer 250 and rotator layer 230 are off. The progression of FIGS. 5(a)-(e) each illustrate a progressive state of light 201 and 202 being propagated through the various layers.

In this example, the e-mirror 300 acts like a reflective layer, and essentially reflects light directed towards the viewer viewing the e-mirror 300. This is shown by light 201 and 202 (which represent light at two different polarization states, orthogonal to each other). As shown, both light 201 and 202′s reflected components (201′ and 202′) are project back to a viewer.

FIGS. 6(a)-(e) illustrate a cross-sectional diagram of e-mirror 300 when both the switch-able polarizer layer 250 and rotator layer 230 are on. Light 201 and 202, similar to the example shown in FIGS. 5(a)-(e) vary in polarization with each other (orthogonally) and are each shown propagating through the various layers of e-mirror 300 in a progressive fashion.

As shown, both light 201 and 202 is propagated through the layers, and ultimately absorbed at various stages. Light 201 is absorbed at layer 250, while light 202 is projected all the way to display 312.

FIG. 7(a) and (b) illustrate a side-view of embodiments (e-mirror 700a and e-mirror 700b) according to an exemplary implementation employing an index matched air gap 320. Also shown in FIGS. 7(a) and (b) and introduced to the construction of the e-mirror systems 700a and 700b is an anti-reflective layer 720.

Referring to FIG. 7(a), an air gap 710 is introduced in between the display assembly 310 and the first reflective polarizer layer 220. Referring to FIG. 7(b), in addition to air gap 710, a first anti-reflective layer 711 is physically disposed (and in abutment) with the display 310, and a second anti-reflective layer 712 is physically disposed (and in abutment) with the first reflective polarizer layer 220. However, in situations where only an air gap 710 is introduced, too much light is reflected. As such, the introduction of the anti-reflective layers 711 and 712 lessens this reflection. The AR layer 720 may be a separate lite of the glass. Doing so prevents another 4% reflection when the display mode is utilized.

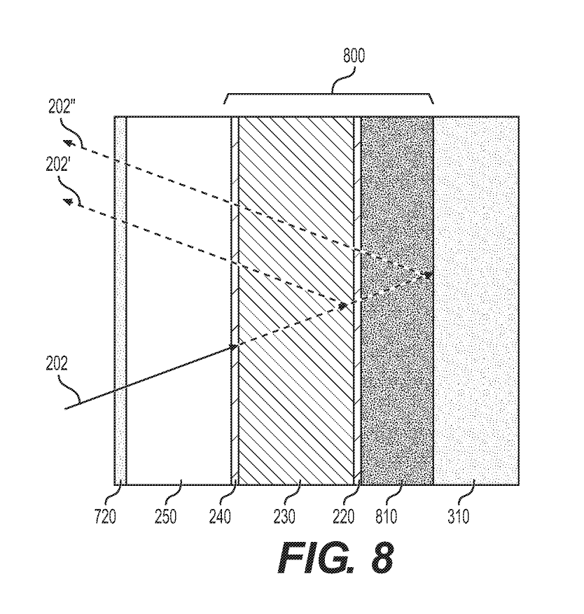

FIG. 8 illustrates a side-view of another embodiment of an e-mirror 800 implementation according to the aspects disclosed herein. The e-mirror 800 shown, in lieu of an air gap for an absorption layer 320, is provided with a liquid optical clear adhesive (LOCA) 810 (or alternatively, with an optical clear adhesive). The LOCA 810 shown in FIG. 8 completely covers the display assembly 310, and the viewable portions of the display 310 through the various layers.

Thus, employing any of the e-mirror implementations disclosed herein (700a, 700b, or 800, for example), an implementer is able to provide an e-mirror system without requiring a toggle operation as done so with the prior art implementations shown in the Background.

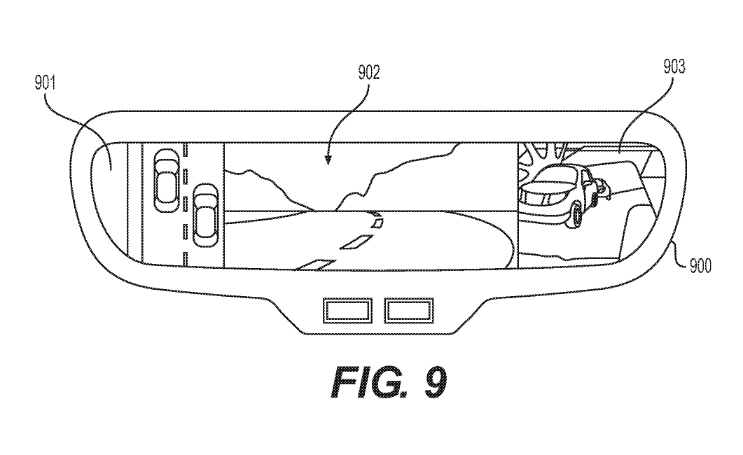

FIG. 9 illustrates an embodiment in which the aspects disclosed herein are employed to implement a sample e-mirror 900. As shown, there are three zones 901, 902, and 903. Zone 901 and 903 are employed for an electronic rendering (for example, showing information displayed from a coupled camera). Simultaneously, zone 902 is employed for a reflective purpose, thereby reflecting content being seen from behind the vehicle.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

We claim:

1. An electronic-mirror (e-mirror) system, comprising:
a backlit display configured to present content;
a first reflective polarizer layer overlapping the backlit display;
an air gap layer introduced between the backlit display and the first reflective polarizer;
a rotator cell layer directly overlapping the first reflective polarizer;
a second reflective polarizer directly overlapping the rotator cell;
a switch-able polarizer directly overlapping the second reflective polarizer; and
a lens directly overlapping the switch-able polarizer.

2. The system according to claim 1, wherein the backlit display, the rotator cell layer and the switch-able polarizer are electrically coupled to a controllable voltage source, and in response to the backlit display being turned on, the controllable voltage source being configured to apply a voltage.

3. The system according to claim 1, wherein the rotator cell layer is defined as an electronically controlled wave plate.

4. The system according to claim 1, wherein the lens is defined as a front glass with antireflective coating.

5. The system according to claim 1, further comprising a first antireflective layer physically in abutment with the backlit display on a surface opposing the air gap, a second antireflective layer physically in abutment with first reflective layer on a surface opposing the air gap.

6. An electronic-mirror (e-mirror) system, comprising:
a backlit display configured to present content;
a first reflective polarizer layer overlapping the backlit display;
an optical adhesive layer introduced between the backlit display and the first reflective polarizer, the optical adhesive layer covering a whole surface of the backlit display viewable through a lens;
a rotator cell layer directly overlapping the first reflective polarizer;
a second reflective polarizer directly overlapping the rotator cell;
a switch-able polarizer directly overlapping the second reflective polarizer; and
the lens directly overlapping the switch-able polarizer.

7. The system according to claim 6, wherein the backlit display, the rotator cell layer and the switch-able polarizer are electrically coupled to a controllable voltage source, and in response to the backlit display being turned on, the controllable voltage source being configured to apply a voltage.

8. The system according to claim 6, wherein the rotator cell layer is defined as an electronically controlled wave plate.

9. The system according to claim 6, wherein the lens is defined as a front glass with antireflective coating.

10. The system according to claim 1, further comprising a first zone and a second zone, wherein the first zone is a reflective surface, and the second zone is a digital electronic screen.

11. The system according to claim 6, further comprising a first zone and a second zone, wherein the first zone is a reflective surface, and the second zone is a digital electronic screen.
